(19) United States
(12) Patent Application Publication
(10) Pub. No.: US 2024/0185101 A1
(43) Pub. Date: Jun. 6, 2024

(54) APPARATUS AND METHOD FOR SPLIT PROCESSING OF MODEL

(71) Applicant: ELECTRONICS AND TELECOMMUNICATIONS RESEARCH INSTITUTE, Daejeon (KR)

(72) Inventors: Chang Sik LEE, Sejong-si (KR); HYEBIN PARK, Daejeon (KR); Seungjae SHIN, Sejong-si (KR); Hong Seok JEON, Daejeon (KR)

(21) Appl. No.: 18/224,762

(22) Filed: Jul. 21, 2023

(30) Foreign Application Priority Data
Dec. 2, 2022 (KR) 10-2022-0166427

(51) Int. Cl. G06N 5/04

(52) U.S. Cl. CPC G06N 5/04

(57) ABSTRACT

An apparatus and method for split processing of a model are provided. The apparatus for the split processing of the model includes a memory including instructions and a processor electrically connected to the memory and configured to execute the instructions. When the instructions are executed by the processor, the processor may be configured to perform a plurality of operations. The plurality of operations may include obtaining information on a plurality of computing nodes that uses at least one layer among a plurality of layers of a model for an artificial intelligence (AI)-based service, obtaining a requirement for the AI-based service, and controlling split processing of the model based on the information and the requirement.

### CROSS-REFERENCE TO RELATED APPLICATION

This application claims the benefit of Korean Patent Application No. 10-2022-0166427 filed on Dec. 2, 2022, in the Korean Intellectual Property Office, the entire disclosure of which is incorporated herein by reference for all purposes.

### BACKGROUND

### 1. Field of the Invention

One or more embodiments relate to an apparatus and method for split processing of a model.

### 2. Description of Related Art

A network may include a cloud server, an edge server, and user equipment. Mobile edge computing may refer to technology of processing data using an edge server adjacent to user equipment. Mobile edge computing may reduce network load and service latency by using the edge server. Mobile edge computing may be used to train a model (e.g., an artificial intelligence (AI) model).

For an AI service requiring high performance, a method of splitting a model and assigning the split models to the cloud server, the edge server, and the user equipment may be used. The cloud server, the edge server, and the user equipment may train the split models and perform inference using the trained models.

The above description has been possessed or acquired by the inventor(s) in the course of conceiving the present disclosure and is not necessarily an art publicly known before the present application is filed.

### SUMMARY

Embodiments provide a control apparatus that may increase the learning speed and reliability of a model by dynamically controlling split processing of the model based on information on a plurality of computing nodes (e.g., information on a data plane).

However, the technical aspects are not limited to the aforementioned aspects, and other technical aspects may be present.

According to an aspect, there is provided an apparatus for split processing of a model including a memory including instructions and a processor electrically connected to the memory and configured to execute the instructions, wherein, when the instructions are executed by the processor, the processor is configured to perform a plurality of operations. The plurality of operations may include obtaining information on a plurality of computing nodes that uses at least one layer among a plurality of layers of a model for an artificial intelligence (AI)-based service, obtaining a requirement for the AI-based service, and controlling split processing of the model based on the information and the requirement.

The obtaining of the information may include receiving at least one of first information on computing of the plurality of computing nodes or second information on a state of the plurality of computing nodes from the plurality of computing nodes.

The second information may include information on mobility of the plurality of computing nodes.

The requirement may include at least one of computing latency or computing accuracy of the plurality of computing nodes that are required for the AI-based service.

The computing latency may include at least one of computing latency of the plurality of computing nodes in a learning process or computing latency of the plurality of computing nodes in an inference process.

The computing accuracy may include at least one of computing accuracy of the plurality of computing nodes in a learning process or computing accuracy of the plurality of computing nodes in an inference process.

The controlling of the split processing of the model may include determining a split point for the plurality of layers.

The controlling of the split processing of the model may include transmitting data related to a first computing node that is included in the plurality of computing nodes to a second computing node that is not included in the plurality of computing nodes.

The transmitting of the data may include transmitting data on the model of the first computing node to the second computing node.

The transmitting of the data on the model to the second computing node may include requesting data on the model from the first computing node based on information related to at least one computing node other than the first computing node among the plurality of computing nodes and transmitting the data on the model to the second computing node.

According to an aspect, there is provided a method for split processing of a model including obtaining information on a plurality of computing nodes that uses at least one layer among a plurality of layers of a model for an AI-based service, obtaining a requirement for the AI-based service, and controlling split processing of the model based on the information and the requirement.

The obtaining of the information may include receiving at least one of first information on computing of the plurality of computing nodes or second information on a state of the plurality of computing nodes from the plurality of computing nodes.

The second information may include information on mobility of the plurality of computing nodes.

The requirement may include at least one of computing latency or computing accuracy of the plurality of computing nodes that are required for the AI-based service.

The computing latency may include at least one of computing latency of the plurality of computing nodes in a learning process or computing latency of the plurality of computing nodes in an inference process.

The computing accuracy may include at least one of computing accuracy of the plurality of computing nodes in a learning process or computing accuracy of the plurality of computing nodes in an inference process.

The controlling of the split processing of the model may include determining a split point for the plurality of layers.

The controlling of the split processing of the model may include transmitting data related to a first computing node that is included in the plurality of computing nodes to a second computing node that is not included in the plurality of computing nodes.

The transmitting of the data may include transmitting data on the model of the first computing node to the second computing node.

The transmitting of the data on the model to the second computing node may include requesting data on the model from the first computing node based on information related to at least one computing node other than the first computing node among the plurality of computing nodes and transmitting the data on the model to the second computing node.

Additional aspects of embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a diagram illustrating a network according to an embodiment;

FIG. 2 is a diagram illustrating a model split processing system according to an embodiment;

FIG. 3 is a diagram illustrating a control apparatus for split processing of a model according to an embodiment;

FIG. 4 is a diagram illustrating an operation of a control apparatus according to an embodiment;

FIG. 5 is a diagram illustrating an operation of a control apparatus according to an embodiment;

FIG. 6 is a diagram illustrating an operation of a control apparatus according to an embodiment;

FIG. 7 is a diagram illustrating an operation of a control apparatus according to an embodiment;

FIG. 8 is a diagram illustrating an operation of a control apparatus according to an embodiment;

FIG. 9 is a diagram illustrating an operation of a control apparatus according to an embodiment;

FIG. 10 is a flowchart illustrating an operation of a control apparatus according to an embodiment;

FIG. 11 is a block diagram schematically illustrating a control apparatus according to an embodiment; and

FIG. 12 is a block diagram schematically illustrating a computing node according to an embodiment.

### DETAILED DESCRIPTION

The following structural or functional descriptions of embodiments described herein are merely intended for the purpose of describing the embodiments described herein and may be implemented in various forms. Thus, actual form of implementation is not limited to the embodiments described herein, and should be understood to include all changes, equivalents, and replacements within the idea and the technical scope of the disclosure.

Although terms of “first,” “second,” and the like are used to explain various components, the components are not limited to such terms. These terms are used only to distinguish one component from another component. For example, a first component may be referred to as a second component, and similarly, the second component may be referred to as the first component within the scope of the present disclosure.

When it is mentioned that one component is “connected” to another component, it may be understood that the one component is directly connected or coupled to another component or still another component is interposed between the two components.

As used herein, the singular forms “a,” “an,” and “the” are intended to include the plural forms as well, unless the context clearly indicates otherwise. As used herein, “A or B,” “at least one of A and B,” “at least one of A or B,” “A, B, or C,” “at least one of A, B, and C,” and “at least one of A, B, or C,” each of which may include any one of the items listed together in the corresponding one of the phrases, or all possible combinations thereof. It will be further understood that the terms “include,” “comprise,” and/or “comprising,” when used in this specification, specify the presence of stated features, integers, steps, operations, elements, components or a combination thereof, but do not preclude the presence or addition of one or more other features, integers, steps, operations, elements, components, and/or groups thereof.

Unless otherwise defined herein, all terms used herein including technical or scientific terms have the same meanings as those generally understood by one of ordinary skill in the art. Terms defined in dictionaries generally used should be construed to have meanings matching contextual meanings in the related art and are not to be construed as an ideal or excessively formal meaning unless otherwise defined herein.

The term “module” used in this document may include a unit implemented in hardware, software, or firmware, and may be used interchangeably with terms such as logic, logic block, component, or circuit. A module may be an integrally constructed component or a minimal unit of the component or part thereof that performs at least one function. For example, according to an embodiment, the module may be implemented as an application-specific integrated circuit (ASIC).

The term “unit” used in this document may refer to software or a hardware component such as a field programmable gate array (FPGA) or an ASIC, and “unit” may perform predetermined roles. However, “unit” is not limited to software or hardware. “Unit” may be configured to be in an addressable storage and may be configured to operate at least one processor. For example, “unit” may include components such as software components, object-oriented software components, class components, and task components, processes, functions, properties, procedures, subroutines, segments of program code, drivers, firmware, microcode, circuitry, data, database, data structures, tables, arrays, and variables. A function provided within the components and “units” may be combined with a smaller number of components and “units” or further divided into additional components and “units.” In addition, the components and “units” may also be implemented to operate at least one central processing unit (CPU) in a device or a secure multimedia card. In addition, “unit” may include at least one processor.

Hereinafter, embodiments will be described in detail with reference to the accompanying drawings. When describing the embodiments with reference to the accompanying drawings, like reference numerals refer to like components and a repeated description related thereto will be omitted.

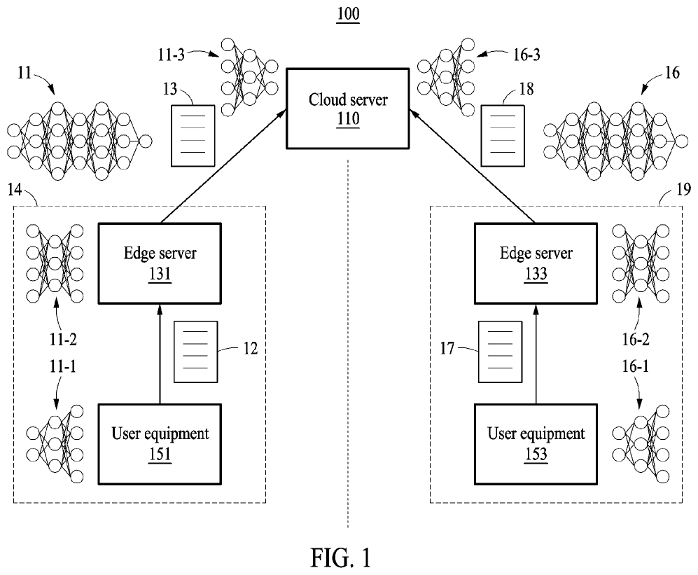

FIG. 1 is a diagram illustrating a network according to an embodiment.

Referring to FIG. 1, according to an embodiment, a network 100 may include a cloud server 110, edge servers 131 and 133, and user equipment 151 and 153. FIG. 1 is an example for convenience of description, and the scope of the present disclosure should not be construed as being limited thereto.

According to an embodiment, a model 11 and a model 16 may be used for an artificial intelligence (AI)-based service. The model 11 and the model 16 may be the same as or different from each other. Hereinafter, for convenience of description, examples in which the model 11 and the model 16 are different models are provided.

According to an embodiment, the models 11 and 16 may be split into a plurality of models. For example, the model 11 may be split into models 11-1 to 11-3, and the model 16 may be split into models 16-1 to 16-3. Each of the models 11-1 to 11-3 may be assigned to the user equipment 151, the edge server 131, and the cloud server 110. Each of the models 16-1 to 16-3 may be assigned to the user equipment 153, the edge server 133, and the cloud server 110.

According to an embodiment, the user equipment 151 and 153 may output computing results 12 and 17 using the split models 11-1 and 16-1. The edge servers 131 and 133 may output computing results 13 and 18 using the computing results 12 and 17 and the split models 11-2 and 16-2. The cloud server 110 may calculate a loss using the computing results 13 and 18 and the split models 11-3 and 16-3 and update the weights of the models 11 and 16. According to an embodiment, the user equipment 151 and 153, the edge servers 131 and 133, and the cloud server 110 may include the models 11 and 16 and also perform an operation based on a split point of the models 11 and 16.

According to an embodiment, the user equipment 151 and 153 may also calculate a loss using a label and an operation result (not shown) received from a node (e.g., the cloud server 110) of a higher layer.

According to an embodiment, when a plurality of pieces of user equipment is involved in the learning process of the models 11 and 16 and/or the inference process using the models 11 and 16, the edge servers 131 and 133 may output computing results (e.g., the computing results 13 and 18) using the computing results (not shown) of the plurality of pieces of user equipment (not shown) and the split models 11-2 and 16-2.

According to an embodiment, the split point for splitting the models 11 and 16 may vary. For example, each of the split models 11-1 to 11-3 and 16-1 to 16-3 may include three layers, while the models 11 and 16 may be split into models having different numbers of layers.

According to an embodiment, the connection relationship between the cloud server 110, the edge servers 131 and 133, and the user equipment 151 and 153 for the split processing (e.g., split learning, split inference, etc.) of the models 11 and 16 may be changed. For example, when the location of the user equipment 151 is changed from a coverage 14 of the edge server 131 to a coverage 19 of the edge server 133, the user equipment 151 may be connected to the edge server 133 and the user equipment 151 may perform the split processing of the model 11. In another example, the connection relationship between the user equipment 151 and 153 and the edge servers 131 and 133 may be changed based on the resources (e.g., a CPU, a memory, etc.) of the servers (e.g., 131, 133, and 110) and the user equipment 151 and 153 and/or the state (e.g., transmission latency, traffic, etc.) of the network 100.

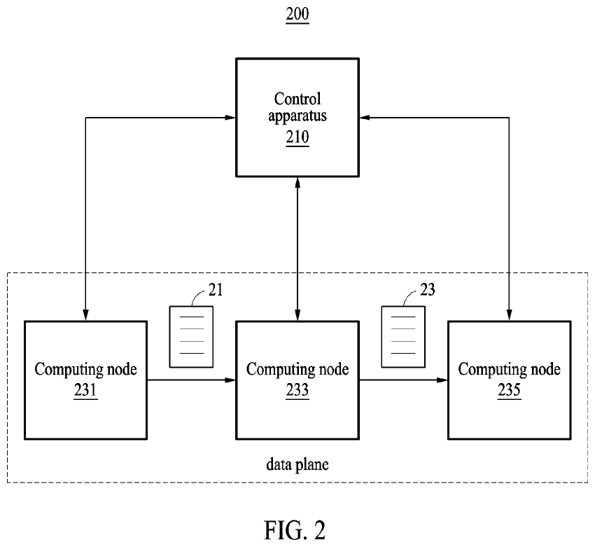

FIG. 2 is a diagram illustrating a model split processing system according to an embodiment.

Referring to FIG. 2, according to an embodiment, a model split processing system 200 may be a system for split processing (e.g., split learning and/or split inference) of a model (e.g., the model 11 or the model 16 of FIG. 1). In this specification, the split learning may indicate learning of split models (e.g., the models 11-1 to 11-3 or the models 16-1 to 16-3 in FIG. 1), and the split inference may indicate inference using split models (e.g., the models 11-1 to 11-3 or the models 16-1 to 16-3 of FIG. 1).

According to an embodiment, the model split processing system 200 may include a plurality of computing nodes 231 to 235 (e.g., the computing nodes (e.g., 151, 131, and 110) or the computing nodes (e.g., 153, 133, and 110) of FIG. 1) and a control apparatus 210.

According to an embodiment, each of the plurality of the computing nodes 231 to 235 may include a model related to a model (e.g., the model 11 or the model 16 of FIG. 1). For example, each of the plurality of the computing nodes 231 to 235 may include a model (e.g., the model 11 or the model 16 of FIG. 1). In another example, each of the plurality of the computing nodes 231 to 235 may include one model among split models (e.g., the models 11-1 to 11-3 or the models 16-1 to 16-3 of FIG. 1). According to an embodiment, when the plurality of the computing nodes 231 to 235 includes an entire model (e.g., the model 11 or the model 16 of FIG. 1), the plurality of the computing nodes 231 to 235 may perform an operation based on a split point for the model (e.g., the model 11 or the model 16 of FIG. 1).

According to an embodiment, each of the computing nodes 231 and 233 may transmit each of computing results 21 and 23 to the computing nodes 233 and 235 of the next layer.

According to an embodiment, the control apparatus 210 may perform control for split processing of a model (e.g., the model 11 or the model 16 of FIG. 1). The control apparatus 210 may receive, from the plurality of the computing nodes 231 to 235, information (e.g., control information) necessary for controlling the split processing. The control information may include first information on an operation of each of the plurality of the computing nodes 231 to 235 and second information on the state of each of the plurality of the computing nodes 231 to 235. The first information may include at least one of computing latency of the plurality of the computing nodes 231 to 235, the size of the computing results 21 and 23 (e.g., the computing results 12, 13, 17, and 18), or latency used for transmitting the computing results 21 and 23 to the computing nodes 233 and 235 of the next layer. The second information may include at least one of mobility information of the plurality of the computing nodes 231 to 235, resource status (e.g., CPU status, memory status, etc.) of the plurality of the computing nodes 231 to 235, or a loss rate for packets transmitted from the plurality of the computing nodes 231 to 235. However, the above information is an example for description, and the control information may include various other types of information.

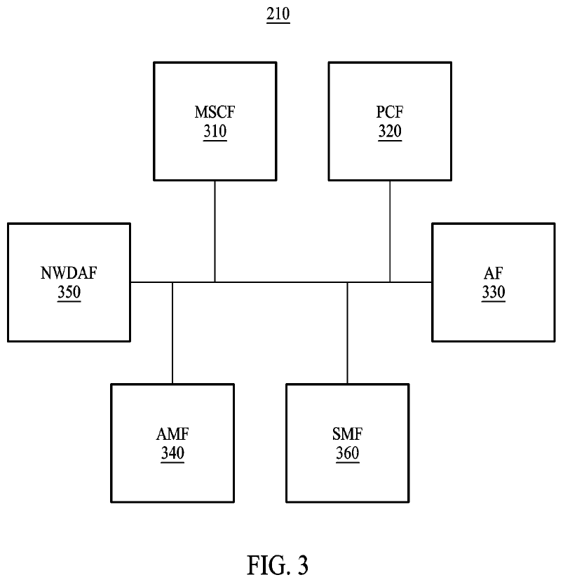

FIG. 3 is a diagram illustrating a control apparatus for split processing of a model according to an embodiment.

Referring to FIG. 3, according to an embodiment, the control apparatus 210 may provide various network functions. The control apparatus 210 may provide, for example, a model split and control function (MSCF) 310, a policy control function (PCF) 320, an application function (AF) 330, a session management function (SMF) 360, an access and mobility management function (AMF) 340, and/or a network data analysis function (NWDAF) 350.

According to an embodiment, the MSCF 310 may be a function for split processing of a model (e.g., the model 11 or the model 16 of FIG. 1). The MSCF 310 may interwork with other functions (e.g., 320 to 350) for split processing of a model (e.g., the model 11 or the model 16 of FIG. 1).

According to an embodiment, the PCF 320 may be a function for managing a policy for a network (e.g., a 5G network) and transmitting the policy to other network functions (e.g., 310 and 330 to 350).

According to an embodiment, the AF 330 may be a function for providing an application service to a user.

According to an embodiment, the SMF 360 may be a function for session management.

According to an embodiment, the AMF 340 may be a function that serves as a gateway for user equipment (e.g., the user equipment 151 and 153 of FIG. 1) to connect to a core network.

According to an embodiment, the NWDAF 350 may be a function for data analysis.

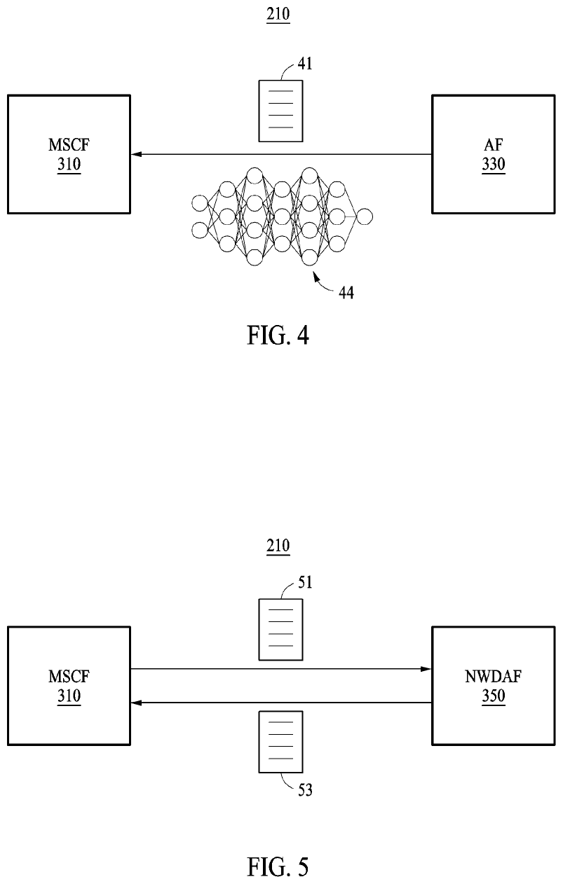

FIG. 4 is a diagram illustrating an operation of a control apparatus according to an embodiment.

Referring to FIG. 4, according to an embodiment, the control apparatus 210 may obtain a model 44 (e.g., the models 11 and 16 of FIG. 1) for the AI-based service and a requirement 41 for the AI-based service (e.g., an analysis service). For example, the MSCF 310 of the control apparatus 210 may receive, from the AF 330, the model 44 for the AI-based service and the requirement 41 for the AI-based service. The requirement 41 may include computing latency, data transmission latency, and computing accuracy of a plurality of computing nodes (e.g., the computing nodes 231 to 235 of FIG. 2). The computing latency may include the latency of computation required in a learning process and/or the latency of computation required in an inference process. The data transmission latency may include the latency of data transmission required in a learning process and/or the latency of data transmission required in an inference process. The computing accuracy may include computing accuracy required in a learning process and/or computing accuracy required in an inference process.

FIG. 5 is a diagram illustrating an operation of a control apparatus according to an embodiment.

Referring to FIG. 5, according to an embodiment, the control apparatus 210 may analyze information (e.g., control information 51 necessary for split processing) received from a plurality of computing nodes (e.g., the computing nodes 231 to 235 of FIG. 2). For example, the MSCF 310 of the control apparatus 210 may request the NWDAF 350 of the control apparatus 210 to analyze the control information 51. The NWDAF 350 may transmit an analysis result 53 of the control information 51 to the MSCF 310.

According to an embodiment, the control apparatus 210 may control split processing of a model (e.g., the models 11 and 16 of FIG. 1 and the model 44 of FIG. 4) based on the analysis result 53 of the control information 51 and/or a requirement (e.g., the requirement 41 of FIG. 4) for the AI-based service.

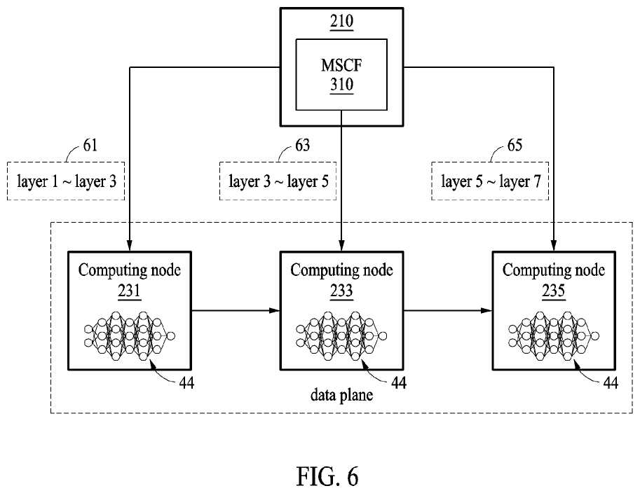

FIG. 6 is a diagram illustrating an operation of a control apparatus according to an embodiment.

FIG. 6 may be a diagram for describing a method of changing a split point of a model 44 (e.g., the models 11 and 16 of FIG. 1).

Referring to FIG. 6, according to an embodiment, the plurality of the computing nodes 231 to 235 (e.g., the computing nodes (e.g., 151, 131, and 110) or the computing nodes (e.g., 153, 133, and 110) of FIG. 1) may include the model 44. The model 44 may be transmitted from the control apparatus 210 (e.g., the MSCF 310 of the control apparatus 210).

According to an embodiment, the control apparatus 210 (e.g., the MSCF 310 of the control apparatus 210) may transmit information 61 to 65 on a split point of the model 44 to the plurality of the computing nodes 231 to 235. The control apparatus 210 may determine a split point of the model 44 based on an analysis result (e.g., the analysis result 53 of FIG. 5) of control information (e.g., the control information 51 of FIG. 5) and a requirement (e.g., the requirement 41 of FIG. 4) for the AI-based service. For example, the control apparatus 210 may determine a layer 3 and a layer 5 to be the split points of the model 44. The control apparatus 210 may transmit the information 61 to 65 on the determined split point to the plurality of the computing nodes 231 to 235. According to an embodiment, the control apparatus 210 may determine a split point of the model 44 on a predetermined cycle and transmit the information 61 to 65 on the determined split point to the plurality of the computing nodes 231 to 235.

According to an embodiment, the plurality of the computing nodes 231 to 235 may perform split processing on the model 44 based on the information 61 to 65. For example, the computing node 231 may train at least one layer (e.g., layers 1 to 3) of the model 44 and perform inference using the at least one layer (e.g., the layers 1 to 3) of the model 44. The computing node 233 may train at least one layer (e.g., layers 3 to 5) of the model 44 and perform inference using the at least one layer (e.g., the layers 3 to 5) of the model 44. The computing node 235 may train at least one layer (e.g., layers 5 to 7) of the model 44 and perform inference using the at least one layer (e.g., the layers 5 to 7) of the model 44.

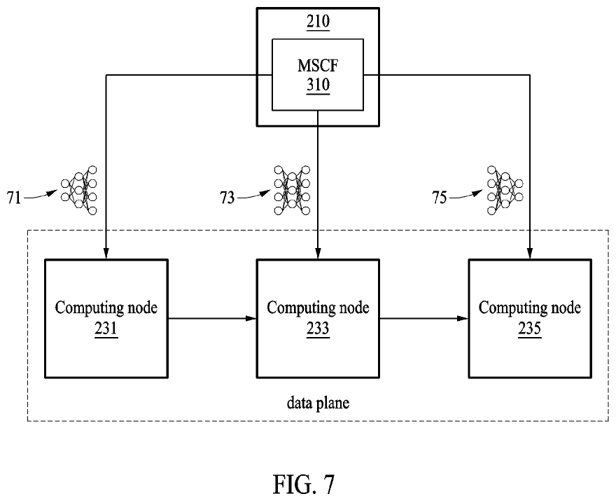

FIG. 7 is a diagram illustrating an operation of a control apparatus according to an embodiment.

FIG. 7 may be a diagram for describing a method of determining a split point of a model (e.g., the model 44 of FIGS. 4 and 6) and transmitting split models 71 to 75.

Referring to FIG. 7, according to an embodiment, each of the plurality of the computing nodes 231 to 235 (e.g., the computing nodes (e.g., 151, 131, and 110) or the computing nodes (e.g., 153, 133, and 110) of FIG. 1) may include one model among the split models 71 to 75 that are generated from the model 44.

According to an embodiment, the control apparatus 210 may determine a split point of the model 44 based on an analysis result (e.g., the analysis result 53 of FIG. 5) of control information (e.g., the control information 51 of FIG. 5) and a requirement (e.g., the requirement 41 of FIG. 4) for the AI-based service. For example, the control apparatus 210 may determine the layer 3 and the layer 5 to be the split points of the model 44. The control apparatus 210 may split the model 44 based on the determined split point and transmit the split models 71 to 75 respectively to the plurality of the computing nodes 231 to 235.

According to an embodiment, the plurality of the computing nodes 231 to 235 may perform split processing of the model 44 using the split models 71 to 75. For example, the computing node 231 may train the model 71 and perform inference using the model 71. The computing node 233 may train the model 73 and perform inference using the model 73. The computing node 235 may train the model 75 and perform inference using the model 75.

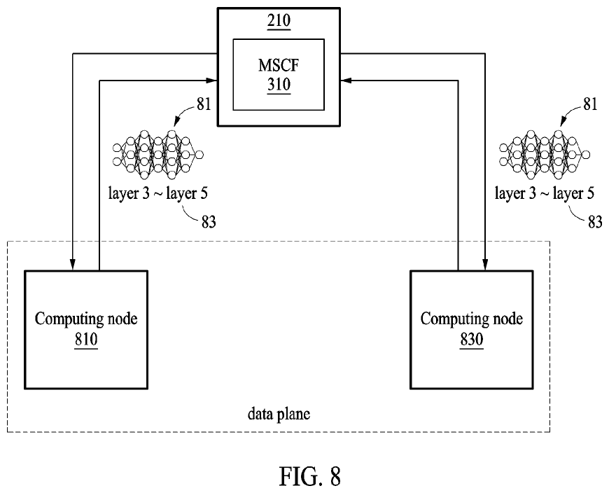

FIG. 8 is a diagram illustrating an operation of a control apparatus according to an embodiment.

FIG. 8 may be a diagram for describing a method of sharing data on a model 81 when a computing node 810 includes the model 81 (e.g., the models 11 and 16 of FIG. 1 and the model 44 of FIGS. 4 and 6).

Referring to FIG. 8, according to an embodiment, a plurality of computing nodes (e.g., the computing nodes (e.g., 151, 131, and 110) of FIG. 1) may be involved in split processing of the model 81. The computing node 810 may be one computing node (e.g., the edge server 131) among the plurality of the computing nodes (e.g., 151, 131, and 110). According to an embodiment, the computing node involved in the split processing of the model 81 may be changed based on the status of the computing nodes (e.g., 151, 131, and 110) and/or the status of a network (e.g., the network 100 of FIG. 1). For example, when the location of the user equipment 151 is changed from the coverage of the edge server 131 (e.g., the coverage 14 of FIG. 1) to the coverage of the edge server 133 (e.g., the coverage 19 of FIG. 1), a computing node 830 (e.g., the edge server 133 of FIG. 1) may perform the split processing of the model 81 on behalf of the computing node 810.

According to an embodiment, the control apparatus 210 (e.g., the MSCF 310 of the control apparatus 210) may perform operations necessary for the split processing of the model 81 based on the status of the computing nodes (e.g., 151, 131, and 110) and/or the status of the network 100. The control apparatus 210 may transmit a list of the plurality of computing nodes (e.g., 151, 133, and 110) involved in the split processing of the model 81 to the computing nodes (e.g., 151, 153, 133, and 110). The control apparatus 210 may request the model 81 (e.g., a model trained by the computing node 810) included in the computing node 810 and information (e.g., a split point of the model 81) on the model 81. The control apparatus 210 may receive the model 81 and information 83 from the computing node 810 and transmit the model 81 and the information 83 to the computing node 830.

According to an embodiment, the computing node 830 may receive the model 81 and the information 83 from the control apparatus 210 and transmit a reception completion message to the control apparatus 210. According to an embodiment, the computing node 830 may perform the split processing of the model 81 based on the model 81 and the information 83. For example, the computing node 830 may train at least one layer (e.g., the layers 3 to 5) of the model 81 and perform inference using the at least one layer (e.g., the layers 3 to 5) of the model 81.

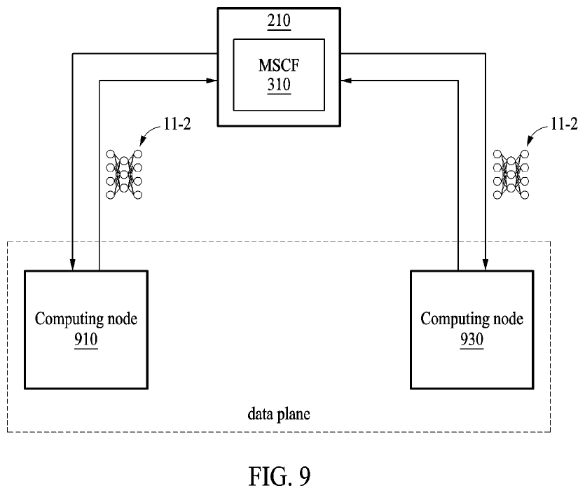

FIG. 9 is a diagram illustrating an operation of a control apparatus according to an embodiment.

FIG. 9 may be a diagram for describing a method of sharing a split model 11-2 when a computing node includes some split models (e.g., the split model 11-2) among split models (e.g., the split models 11-1 to 11-3 of FIG. 1).

Referring to FIG. 9, according to an embodiment, a plurality of computing nodes (e.g., the computing nodes (e.g., 151, 131, and 110) of FIG. 1) may be involved in split processing of the model 11. A computing node 910 may be one computing node (e.g., the edge server 131) among the plurality of the computing nodes (e.g., 151, 131, and 110). According to an embodiment, the computing node involved in the split processing of the model 11 may be changed based on the status of the computing nodes (e.g., 151, 131, and 110) and/or the status of a network (e.g., the network 100 of FIG. 1). For example, when the location of the user equipment 151 is changed from the coverage of the edge server 131 (e.g., the coverage 14 of FIG. 1) to the coverage of the edge server 133 (e.g., the coverage 19 of FIG. 1), a computing node 930 (e.g., the edge server 133 of FIG. 1) may perform split processing of the model 11 on behalf of the computing node 910.

According to an embodiment, the control apparatus 210 (e.g., the MSCF 310 of the control apparatus 210) may perform operations necessary for the split processing of the model 11 based on the status of the computing nodes (e.g., 151, 131, and 110) and/or the status of the network 100. The control apparatus 210 may transmit a list of the plurality of computing nodes (e.g., 151, 133, and 110) involved in the split processing of the model 11 to the computing nodes (e.g., 151, 153, 133, and 110). The control apparatus 210 may request the split model 11-2 included in the computing node 910 (e.g., a model trained by the computing node 910). The control apparatus 210 may receive the split model 11-2 from the computing node 910 and transmit the split model 11-2 to the computing node 930.

According to an embodiment, the computing node 930 may receive the split model 11-2 from the control apparatus 210 and transmit a reception completion message to the control apparatus 210. According to an embodiment, the computing node 930 may perform the split processing of the model 11 using the split model 11-2. For example, the computing node 930 may train the split model 11-2 and perform inference using the split model 11-2.

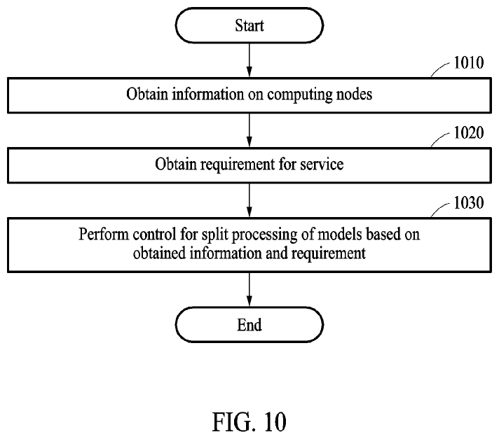

FIG. 10 is a flowchart illustrating an operation of a control apparatus according to an embodiment.

Referring to FIG. 10, according to an embodiment, operations 1010 to 1030 may be sequentially performed, however, embodiments are not limited thereto. For example, the order of operations 1010 and 1020 may be changed or operations 1010 and 1020 may be performed in parallel. Operations 1010 to 1030 may be substantially the same as those of the control apparatus (e.g., the control apparatus 210 of FIGS. 2 to 9) described above with reference to FIGS. 2 to 9. Accordingly, a repeated description thereof is omitted.

In operation 1010, the control apparatus 210 may obtain information (e.g., information on a data plane (e.g., the control information 51 of FIG. 5)) on a plurality of computing nodes (e.g., the computing nodes (e.g., 110, 131, 133, 151, and 153) of FIG. 1, the computing nodes 231 to 235 of FIGS. 2, 6, and 7, the computing nodes 810 and 830 of FIG. 8, and the computing nodes 910 and 930 of FIG. 9) that use at least one layer among a plurality of layers of a model (e.g., the models 11 and 16 of FIG. 1, the model 44 of FIGS. 4 and 6, and the model 81 of FIG. 8) for a service (e.g., the AI-based service).

In operation 1020, the control apparatus 210 may obtain a requirement (e.g., the requirement 41 of FIG. 4) for a service.

In operation 1030, the control apparatus 210 may perform control for the split processing (e.g., split learning, split inference, etc.) of the models 11, 16, 44, and 81 based on the obtained information 51 and requirement 41.

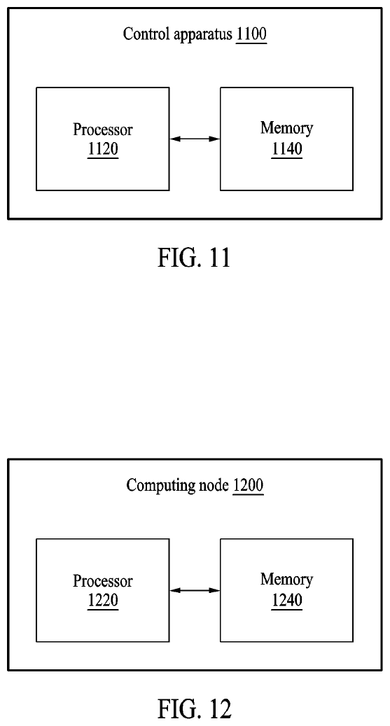

FIG. 11 is a block diagram schematically illustrating a control apparatus according to an embodiment.

Referring to FIG. 11, according to an embodiment, a control apparatus 1100 (e.g., the control apparatus 210 of FIGS. 2 to 9) may include a memory 1140 and a processor 1120.

The memory 1140 may store instructions (or programs) executable by the processor 1120. For example, the instructions may include instructions for performing an operation of the processor 1120 and/or an operation of each component of the processor 1120.

The processor 1120 may process data stored in the memory 1140. The processor 1120 may execute computer-readable code (e.g., software) stored in the memory 1140 and instructions triggered by the processor 1120.

The processor 1120 may be a hardware-implemented data processing device having a circuit that is physically structured to execute desired operations. For example, the desired operations may include code or instructions included in a program.

The hardware-implemented data processing device may include, for example, a microprocessor, a CPU, a processor core, a multi-core processor, a multiprocessor, an ASIC, and an FPGA.

An operation performed by the processor 1120 may be substantially the same as the operation of the control apparatus 210 described above with reference to FIGS. 2 to 9. Accordingly, a detailed description thereof is omitted.

FIG. 12 is a block diagram schematically illustrating a computing node according to an embodiment.

Referring to FIG. 12, according to an embodiment, a computing node 1200 (e.g., the computing nodes (e.g., 110, 131, 133, 151, and 153) of FIG. 1), the computing nodes 231 to 235 of FIGS. 2, 6, and 7, the computing nodes 810 and 830 of FIG. 8, and the computing nodes 910 and 930 of FIG. 9 may include a memory 1240 and a processor 1220.

The memory 1240 may store instructions (or programs) executable by the processor 1220. For example, the instructions may include instructions for performing an operation of the processor 1220 and/or an operation of each component of the processor 1220.

The processor 1220 may process data stored in the memory 1240. The processor 1220 may execute computer-readable code (e.g., software) stored in the memory 1240 and instructions triggered by the processor 1220.

The processor 1220 may be a hardware-implemented data processing device having a circuit that is physically structured to execute desired operations. For example, the desired operations may include code or instructions included in a program.

The hardware-implemented data processing device may include, for example, a microprocessor, a CPU, a processor core, a multi-core processor, a multiprocessor, an ASIC, and an FPGA.

An operation performed by the processor 1220 may be substantially the same as the operation of the computing nodes (e.g., 110, 131, 133, 151, 153, 231 to 235, 810, 830, 910, and 930) described above with reference to FIGS. 1, 2, and 6 to 9. Accordingly, a detailed description thereof is omitted.

The components described in the embodiments may be implemented by hardware components including, for example, at least one digital signal processor (DSP), a processor, a controller, an ASIC, a programmable logic element, such as an FPGA, other electronic devices, or combinations thereof. At least some of the functions or the processes described in the embodiments may be implemented by software, and the software may be recorded on a recording medium. The components, the functions, and the processes described in the embodiments may be implemented by a combination of hardware and software.

The embodiments described herein may be implemented using hardware components, software components, or a combination thereof. For example, a device, a method, and a component described in the examples may be implemented using one or more general-purpose or special-purpose computers, such as, for example, a processor, a controller, an arithmetic logic unit (ALU), a digital signal processor, a microcomputer, an FPGA, a programmable logic unit (PLU), a microprocessor, or any other device capable of responding to and executing instructions in a defined manner. The processing device may run an operating system (OS) and one or more software applications that run on the OS. The processing device also may access, store, manipulate, process, and generate data in response to execution of the software. For purpose of simplicity, the description of the processing device is used as singular. However, one skilled in the art will appreciate that the processing device may include multiple processing elements and multiple types of processing elements. For example, the processing device may include multiple processors or a processor and a controller. In addition, different processing configurations are possible, such as parallel processors.

The software may include a computer program, a piece of code, an instruction, or some combination thereof, to independently or collectively instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software may also be distributed over network coupled computer systems so that the software is stored and executed in a distributed fashion. The software and data may be stored by one or more non-transitory computer readable recording media.

The method according to the above-described embodiments may be recorded in non-transitory computer-readable media including program instructions to implement various operations which may be performed by a computer. The media may also include the program instructions, data files, data structures, and the like alone or in combination. The program instructions recorded on the media may be those specially designed and constructed for the purposes of the embodiments, or they may be of the well-known kind and available to those having skill in the computer software arts. Examples of non-transitory computer-readable media include magnetic media such as hard disks, floppy disks, and magnetic tape; optical media such as CD ROM discs and DVDs; magneto-optical media such as floptical disks; and hardware devices that are specially configured to store and perform program instructions, such as read-only memory (ROM), random access memory (RAM), flash memory, and the like. Examples of program instructions include both machine code, such as code produced by a compiler, and higher-level code that may be executed by the computer using an interpreter.

The above-described hardware devices may be configured to act as one or more software modules in order to perform the operations of the above-described embodiments, or vice versa.

While this disclosure includes embodiments illustrated with reference to limited drawings, it will be apparent to one of ordinary skill in the art that various changes in form and details may be made in these embodiments without departing from the spirit and scope of the claims and their equivalents. Descriptions of features or aspects in each embodiment are to be considered as being applicable to similar features or aspects in other embodiments. Suitable results may be achieved if the described techniques are performed in a different order, and/or if components in a described system, architecture, device, or circuit are coupled or combined in a different manner and/or replaced or supplemented by other components or their equivalents.

Therefore, the scope of the disclosure is defined not by the detailed description, but by the claims and their equivalents, and all variations within the scope of the claims and their equivalents are to be construed as being included in the disclosure.

What is claimed is:

1. An apparatus for split processing of a model, the apparatus comprising:
a memory comprising instructions; and
a processor electrically connected to the memory and configured to execute the instructions,
wherein, when the instructions are executed by the processor, the processor is configured to perform a plurality of operations,
wherein the plurality of operations comprises:
obtaining information on a plurality of computing nodes that uses at least one layer among a plurality of layers of a model for an artificial intelligence (AI)-based service;
obtaining a requirement for the AI-based service; and
controlling split processing of the model based on the information and the requirement.

2. The apparatus of claim 1, wherein the obtaining of the information comprises receiving at least one of first information on computing of the plurality of computing nodes or second information on a state of the plurality of computing nodes from the plurality of computing nodes.

3. The apparatus of claim 2, wherein the second information comprises information on mobility of the plurality of computing nodes.

4. The apparatus of claim 1, wherein the requirement comprises at least one of computing latency or computing accuracy of the plurality of computing nodes that are required for the AI-based service.

5. The apparatus of claim 4, wherein the computing latency comprises at least one of computing latency of the plurality of computing nodes in a learning process or computing latency of the plurality of computing nodes in an inference process.

6. The apparatus of claim 4, wherein the computing accuracy comprises at least one of computing accuracy of the plurality of computing nodes in a learning process or computing accuracy of the plurality of computing nodes in an inference process.

7. The apparatus of claim 1, wherein the controlling of the split processing of the model comprises determining a split point for the plurality of layers.

8. The apparatus of claim 1, wherein the controlling of the split processing of the model comprises transmitting data related to a first computing node that is included in the plurality of computing nodes to a second computing node that is not included in the plurality of computing nodes.

9. The apparatus of claim 8, wherein the transmitting of the data comprises transmitting data on the model of the first computing node to the second computing node.

10. The apparatus of claim 9, wherein the transmitting of the data on the model to the second computing node comprises:
requesting data on the model from the first computing node based on information related to at least one computing node other than the first computing node among the plurality of computing nodes; and
transmitting the data on the model to the second computing node.

11. A method for split processing of a model, the method comprising:
obtaining information on a plurality of computing nodes that uses at least one layer among a plurality of layers of a model for an artificial intelligence (AI)-based service;
obtaining a requirement for the AI-based service; and
controlling split processing of the model based on the information and the requirement.

12. The method of claim 11, wherein the obtaining of the information comprises receiving at least one of first information on computing of the plurality of computing nodes or second information on a state of the plurality of computing nodes from the plurality of computing nodes.

13. The method of claim 12, wherein the second information comprises information on mobility of the plurality of computing nodes.

14. The method of claim 11, wherein the requirement comprises at least one of computing latency or computing accuracy of the plurality of computing nodes that are required for the AI-based service.

15. The method of claim 14, wherein the computing latency comprises at least one of computing latency of the plurality of computing nodes in a learning process or computing latency of the plurality of computing nodes in an inference process.

16. The method of claim 14, wherein the computing accuracy comprises at least one of computing accuracy of the plurality of computing nodes in a learning process or computing accuracy of the plurality of computing nodes in an inference process.

17. The method of claim 11, wherein the controlling of the split processing of the model comprises determining a split point for the plurality of layers.

18. The method of claim 11, wherein the controlling of the split processing of the model comprises transmitting data related to a first computing node that is included in the plurality of computing nodes to a second computing node that is not included in the plurality of computing nodes.

19. The method of claim 18, wherein the transmitting of the data comprises transmitting data on the model of the first computing node to the second computing node.

20. The method of claim 19, wherein the transmitting of the data on the model to the second computing node comprises:
requesting data on the model from the first computing node based on information related to at least one computing node other than the first computing node among the plurality of computing nodes; and
transmitting the data on the model to the second computing node.
